(19) United States
(12) Patent Application Publication
(10) Pub. No.: US 2007/0052695 A1
(43) Pub. Date: Mar. 8, 2007

(54) Generating and displaying spatially offset sub-frames

(76) Inventors: Ted W. Barnes, Corvallis, OR (US); Donald J. Fasen, Boise, ID (US); Matthew D. Beasley, Dallas, OR (US); Arnold W. Larson, Corvallis, OR (US); P. Guy Howard, Junction City, OR (US); Stan E. Leigh, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/221,271

(22) Filed: Sep. 7, 2005

(51) Int. Cl. G09G 5/00

(52) U.S. Cl. 345/204

(57) ABSTRACT

A system for displaying an image using a first sub-frame and a second sub-frame is provided. The system comprises an image shifter configured to cause the first sub-frame to be displayed at a first position on a display surface and the second sub-frame to be displayed at a second position on the display surface, a sensor configured to detect a movement of the image shifter, and a controller configured to receive movement information associated with the movement of the image shifter from the sensor.

### CROSS-REFERENCE TO RELATED APPLICATIONS

This application is related to U.S. patent application Ser. No. 10/213,555, filed on Aug. 7, 2002, entitled IMAGE DISPLAY SYSTEM AND METHOD; U.S. patent application Ser. No. 10/242,195, filed on Sep. 11, 2002, entitled IMAGE DISPLAY SYSTEM AND METHOD; U.S. patent application Ser. No. 10/242,545, filed on Sep. 11, 2002, entitled IMAGE DISPLAY SYSTEM AND METHOD; U.S. patent application Ser. No. 10/631,681, filed Jul. 31, 2003, entitled GENERATING AND DISPLAYING SPATIALLY OFFSET SUB-FRAMES; U.S. patent application Ser. No. 10/632,042, filed Jul. 31, 2003, entitled GENERATING AND DISPLAYING SPATIALLY OFFSET SUB-FRAMES; U.S. patent application Ser. No. 10/672,845, filed Sep. 26, 2003, entitled GENERATING AND DISPLAYING SPATIALLY OFFSET SUB-FRAMES; U.S. patent application Ser. No. 10/672,544, filed Sep. 26, 2003, entitled GENERATING AND DISPLAYING SPATIALLY OFFSET SUB-FRAMES; U.S. patent application Ser. No. 10/697,605, filed Oct. 30, 2003, entitled GENERATING AND DISPLAYING SPATIALLY OFFSET SUB-FRAMES ON A DIAMOND GRID; U.S. patent application Ser. No. 10/696,888, filed Oct. 30, 2003, entitled GENERATING AND DISPLAYING SPATIALLY OFFSET SUB-FRAMES ON DIFFERENT TYPES OF GRIDS; U.S. patent application Ser. No. 10/697,830, filed Oct. 30, 2003, entitled IMAGE DISPLAY SYSTEM AND METHOD; U.S. patent application Ser. No. 10/750,591, filed Dec. 31, 2003, entitled DISPLAYING SPATIALLY OFFSET SUB-FRAMES WITH A DISPLAY DEVICE HAVING A SET OF DEFECTIVE DISPLAY PIXELS; U.S. patent application Ser. No. 10/768,621, filed Jan. 30, 2004, entitled GENERATING AND DISPLAYING SPATIALLY OFFSET SUB-FRAMES; U.S. patent application Ser. No. 10/768,215, filed Jan. 30, 2004, entitled DISPLAYING SUB-FRAMES AT SPATIALLY OFFSET POSITIONS ON A CIRCLE; U.S. patent application Ser. No. 10/821,135, filed Apr. 8, 2004, entitled GENERATING AND DISPLAYING SPATIALLY OFFSET SUB-FRAMES; U.S. patent application Ser. No. 10/821,130, filed Apr. 8, 2004, entitled GENERATING AND DISPLAYING SPATIALLY OFFSET SUB-FRAMES; U.S. patent application Ser. No. 10/820,952, filed Apr. 8, 2004, entitled GENERATING AND DISPLAYING SPATIALLY OFFSET SUB-FRAMES; U.S. patent application Ser. No. 10/864,125, Docket No. 200401412-1, filed Jun. 9, 2004, entitled GENERATING AND DISPLAYING SPATIALLY OFFSET SUB-FRAMES; U.S. patent application Ser. No. 10/868,719, filed Jun. 15, 2004, entitled GENERATING AND DISPLAYING SPATIALLY OFFSET SUB-FRAMES, and U.S. patent application Ser. No. 10/868,638, filed Jun. 15, 2004, entitled GENERATING AND DISPLAYING SPATIALLY OFFSET SUB-FRAMES. Each of the above U.S. patent applications is assigned to the assignee of the present invention, and is hereby incorporated by reference herein.

### BACKGROUND

A conventional system or device for displaying an image, such as a display, projector, or other imaging system, produces a displayed image by addressing an array of individual picture elements or pixels arranged in horizontal rows and vertical columns. A resolution of the displayed image is defined as the number of horizontal rows and vertical columns of individual pixels forming the displayed image. The resolution of the displayed image is affected by a resolution of the display device itself as well as a resolution of the image data processed by the display device and used to produce the displayed image.

Typically, to increase a resolution of the displayed image, the resolution of the display device as well as the resolution of the image data used to produce the displayed image needs to be increased. Increasing the resolution of the display device, however, increases cost and complexity of the display device.

At times, certain display techniques may be used to increase the resolution of various types of graphical images. Display devices, however, may not include specialized components that would most efficiently implement these techniques. It would be desirable to be able to operate one or more components of a display device in ways suited for a display technique. In addition, it would be desirable to optimize the control of components of a display device that are suited for a display technique.

### SUMMARY

One form of the present invention provides a system for displaying an image using a first sub-frame and a second sub-frame. The system comprises an image shifter configured to cause the first sub-frame to be displayed at a first position on a display surface and the second sub-frame to be displayed at a second position on the display surface, a sensor configured to detect a movement of the image shifter, and a controller configured to receive movement information associated with the movement of the image shifter from the sensor.

### BRIEF DESCRIPTION OF THE DRAWINGS

FIG. 1 is a block diagram illustrating an image display system according to one embodiment of the present invention.

FIGS. 2A-2C are schematic diagrams illustrating the display of two sub-frames according to one embodiment of the present invention.

FIGS. 3A-3E are schematic diagrams illustrating the display of four sub-frames according to one embodiment of the present invention.

FIGS. 4A-4E are schematic diagrams illustrating the display of a pixel with an image display system according to one embodiment of the present invention.

FIG. 5 is a block diagram illustrating a display device with an image shifter according to one embodiment of the present invention.

FIG. 6 is a flow chart illustrating a method for controlling an optical element according to one embodiment of the present invention.

FIG. 7 is a block diagram illustrating a controller for controlling an optical element according to one embodiment of the present invention.

FIG. 8 is a block diagram illustrating a controller for controlling an optical element according to one embodiment of the present invention.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

I. Spatial and Temporal Shifting of Sub-Frames

Some display systems, such as some digital light projectors, may not have sufficient resolution to display some high resolution images. Such systems can be configured to give the appearance to the human eye of higher resolution images by displaying spatially and temporally shifted lower resolution images. The lower resolution images are referred to as sub-frames. A problem of sub-frame generation, which is addressed by embodiments of the present invention, is to determine appropriate values for the sub-frames so that the displayed sub-frames are close in appearance to how the high-resolution image from which the sub-frames were derived would appear if directly displayed.

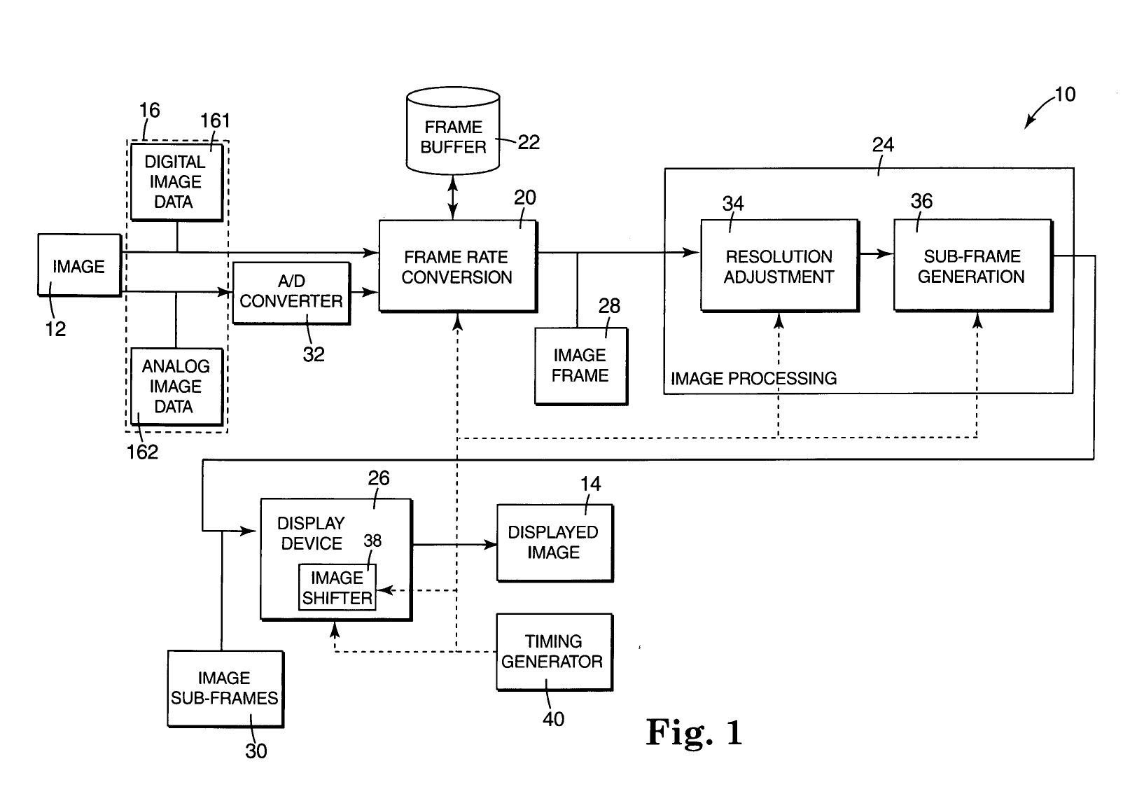

One embodiment of a display system that provides the appearance of enhanced resolution through temporal and spatial shifting of sub-frames is described in the U.S. patent applications cited above, and is summarized below with reference to FIGS. 1-4E.

FIG. 1 is a block diagram illustrating an image display system 10 according to one embodiment of the present invention. Image display system 10 facilitates processing of an image 12 to create a displayed image 14. Image 12 is defined to include any pictorial, graphical, and/or textural characters, symbols, illustrations, and/or other representation of information. Image 12 is represented, for example, by image data 16. Image data 16 includes individual picture elements or pixels of image 12. While one image is illustrated and described as being processed by image display system 10, it is understood that a plurality or series of images may be processed and displayed by image display system 10.

In one embodiment, image display system 10 includes a frame rate conversion unit 20 and an image frame buffer 22, an image processing unit 24, and a display device 26. As described below, frame rate conversion unit 20 and image frame buffer 22 receive and buffer image data 16 for image 12 to create an image frame 28 for image 12. Image processing unit 24 processes image frame 28 to define one or more image sub-frames 30 for image frame 28, and display device 26 temporally and spatially displays image sub-frames 30 to produce displayed image 14.

Image display system 10, including frame rate conversion unit 20 and/or image processing unit 24, includes hardware, software, firmware, or a combination of these. In one embodiment, one or more components of image display system 10, including frame rate conversion unit 20 and/or image processing unit 24, are included in a computer, computer server, or other microprocessor-based system capable of performing a sequence of logic operations. In addition, processing can be distributed throughout the system with individual portions being implemented in separate system components.

Image data 16 may include digital image data 161 or analog image data 162. To process analog image data 162, image display system 10 includes an analog-to-digital (A/D) converter 32. As such, A/D converter 32 converts analog image data 162 to digital form for subsequent processing. Thus, image display system 10 may receive and process digital image data 161 and/or analog image data 162 for image 12.

Frame rate conversion unit 20 receives image data 16 for image 12 and buffers or stores image data 16 in image frame buffer 22. More specifically, frame rate conversion unit 20 receives image data 16 representing individual lines or fields of image 12 and buffers image data 16 in image frame buffer 22 to create image frame 28 for image 12. Image frame buffer 22 buffers image data 16 by receiving and storing all of the image data for image frame 28, and frame rate conversion unit 20 creates image frame 28 by subsequently retrieving or extracting all of the image data for image frame 28 from image frame buffer 22. As such, image frame 28 is defined to include a plurality of individual lines or fields of image data 16 representing an entirety of image 12. Thus, image frame 28 includes a plurality of columns and a plurality of rows of individual pixels representing image 12.

Frame rate conversion unit 20 and image frame buffer 22 can receive and process image data 16 as progressive image data and/or interlaced image data. With progressive image data, frame rate conversion unit 20 and image frame buffer 22 receive and store sequential fields of image data 16 for image 12. Thus, frame rate conversion unit 20 creates image frame 28 by retrieving the sequential fields of image data 16 for image 12. With interlaced image data, frame rate conversion unit 20 and image frame buffer 22 receive and store odd fields and even fields of image data 16 for image 12. For example, all of the odd fields of image data 16 are received and stored and all of the even fields of image data 16 are received and stored. As such, frame rate conversion unit 20 de-interlaces image data 16 and creates image frame 28 by retrieving the odd and even fields of image data 16 for image 12.

Image frame buffer 22 includes memory for storing image data 16 for one or more image frames 28 of respective images 12. Thus, image frame buffer 22 constitutes a database of one or more image frames 28. Examples of image frame buffer 22 include non-volatile memory (e.g., a hard disk drive or other persistent storage device) and may include volatile memory (e.g., random access memory (RAM)).

By receiving image data 16 at frame rate conversion unit 20 and buffering image data 16 with image frame buffer 22, input timing of image data 16 can be decoupled from a timing requirement of display device 26. More specifically, since image data 16 for image frame 28 is received and stored by image frame buffer 22, image data 16 can be received as input at any rate. As such, the frame rate of image frame 28 can be converted to the timing requirement of display device 26. Thus, image data 16 for image frame 28 can be extracted from image frame buffer 22 at a frame rate of display device 26.

In one embodiment, image processing unit 24 includes a resolution adjustment unit 34 and a sub-frame generation unit 36. As described below, resolution adjustment unit 34 receives image data 16 for image frame 28 and adjusts a resolution of image data 16 for display on display device 26, and sub-frame generation unit 36 generates a plurality of image sub-frames 30 for image frame 28. More specifically, image processing unit 24 receives image data 16 for image frame 28 at an original resolution and processes image data 16 to increase, decrease, and/or leave unaltered the resolution of image data 16. Accordingly, with image processing unit 24, image display system 10 can receive and display image data 16 of varying resolutions.

Sub-frame generation unit 36 receives and processes image data 16 for image frame 28 to define a plurality of image sub-frames 30 for image frame 28. If resolution adjustment unit 34 has adjusted the resolution of image data 16, sub-frame generation unit 36 receives image data 16 at the adjusted resolution. The adjusted resolution of image data 16 may be increased, decreased, or the same as the original resolution of image data 16 for image frame 28. Sub-frame generation unit 36 generates image sub-frames 30 with a resolution which matches the resolution of display device 26. Image sub-frames 30 are each of an area equal to image frame 28. Sub-frames 30 each include a plurality of columns and a plurality of rows of individual pixels representing a subset of image data 16 of image 12, and have a resolution that matches the resolution of display device 26.

Each image sub-frame 30 includes a matrix or array of pixels for image frame 28. Image sub-frames 30 are spatially offset from each other such that each image sub-frame 30 includes different pixels and/or portions of pixels. As such, image sub-frames 30 are offset from each other by a vertical distance and/or a horizontal distance, as described below.

Display device 26 receives image sub-frames 30 from image processing unit 24 and sequentially displays image sub-frames 30 to create displayed image 14. More specifically, as image sub-frames 30 are spatially offset from each other, display device 26 displays image sub-frames 30 in different positions according to the spatial offset of image sub-frames 30, as described below. As such, display device 26 alternates between displaying image sub-frames 30 for image frame 28 to create displayed image 14. Accordingly, display device 26 displays an entire sub-frame 30 for image frame 28 at one time.

In one embodiment, display device 26 performs one cycle of displaying image sub-frames 30 for each image frame 28. Display device 26 displays image sub-frames 30 so as to be spatially and temporally offset from each other. In one embodiment, display device 26 optically steers image sub-frames 30 to create displayed image 14. As such, individual pixels of display device 26 are addressed to multiple locations.

In one embodiment, display device 26 includes an image shifter 38. Image shifter 38 spatially alters or offsets the position of image sub-frames 30 as displayed by display device 26. More specifically, image shifter 38 varies the position of display of image sub-frames 30, as described below, to produce displayed image 14.

In one embodiment, display device 26 includes a light modulator for modulation of incident light. The light modulator includes, for example, a plurality of micro-mirror devices arranged to form an array of micro-mirror devices. As such, each micro-mirror device constitutes one cell or pixel of display device 26. Display device 26 may form part of a display, projector, or other imaging system.

In one embodiment, image display system 10 includes a timing generator 40. Timing generator 40 communicates, for example, with frame rate conversion unit 20, image processing unit 24, including resolution adjustment unit 34 and sub-frame generation unit 36, and display device 26, including image shifter 38. As such, timing generator 40 synchronizes buffering and conversion of image data 16 to create image frame 28, processing of image frame 28 to adjust the resolution of image data 16 and generate image sub-frames 30, and positioning and displaying of image sub-frames 30 to produce displayed image 14. Accordingly, timing generator 40 controls timing of image display system 10 such that entire sub-frames of image 12 are temporally and spatially displayed by display device 26 as displayed image 14.

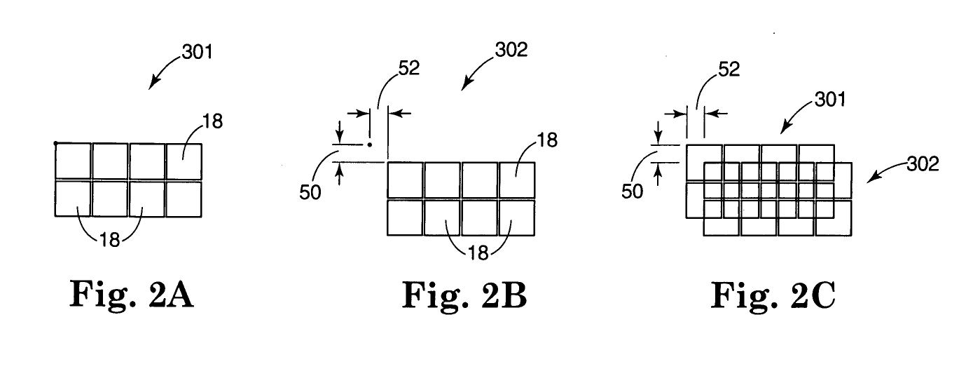

In one embodiment, as illustrated in FIGS. 2A and 2B, image processing unit 24 defines two image sub-frames 30 for image frame 28. More specifically, image processing unit 24 defines a first sub-frame 301 and a second sub-frame 302 for image frame 28. As such, first sub-frame 301 and second sub-frame 302 each include a plurality of columns and a plurality of rows of individual pixels 18 of image data 16. Thus, first sub-frame 301 and second sub-frame 302 each constitute an image data array or pixel matrix of a subset of image data 16.

In one embodiment, as illustrated in FIG. 2B, second sub-frame 302 is offset from first sub-frame 301 by a vertical distance 50 and a horizontal distance 52. As such, second sub-frame 302 is spatially offset from first sub-frame 301 by a predetermined distance. In one illustrative embodiment, vertical distance 50 and horizontal distance 52 are each approximately one-half of one pixel.

As illustrated in FIG. 2C, display device 26 alternates between displaying first sub-frame 301 in a first position and displaying second sub-frame 302 in a second position spatially offset from the first position. More specifically, display device 26 shifts display of second sub-frame 302 relative to display of first sub-frame 301 by vertical distance 50 and horizontal distance 52. As such, pixels of first sub-frame 301 overlap pixels of second sub-frame 302. In one embodiment, display device 26 performs one cycle of displaying first sub-frame 301 in the first position and displaying second sub-frame 302 in the second position for image frame 28. Thus, second sub-frame 302 is spatially and temporally displaced relative to first sub-frame 301. The display of two temporally and spatially shifted sub-frames in this manner is referred to herein as two-position processing. In other embodiments, sub-frames 301 and 302 are spatially displaced using other vertical and/or horizontal distances (e.g., using only vertical displacements or only horizontal displacements).

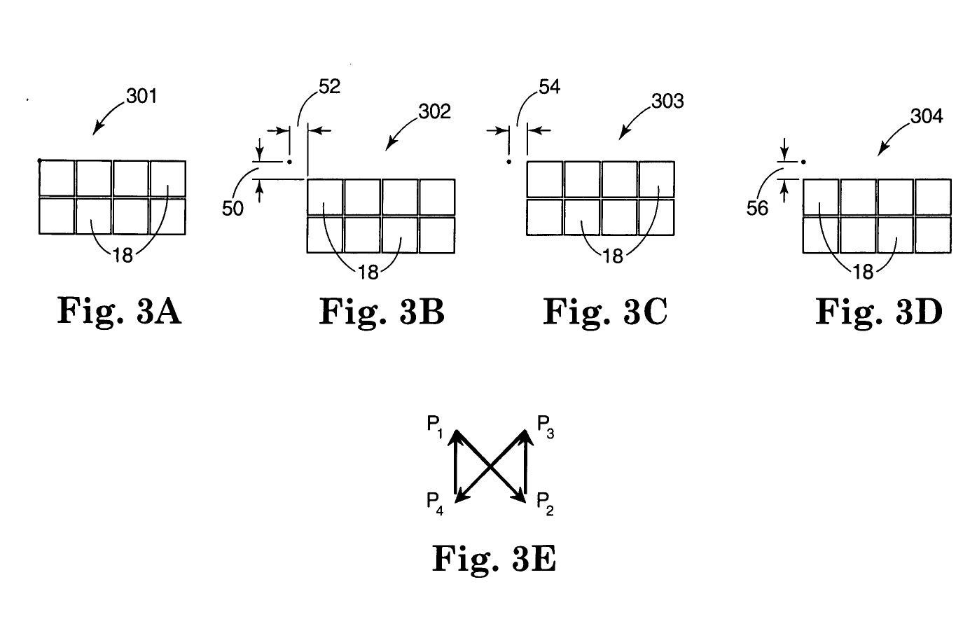

In another embodiment, as illustrated in FIGS. 3A-3D, image processing unit 24 defines four image sub-frames 30 for image frame 28. More specifically, image processing unit 24 defines a first sub-frame 301, a second sub-frame 302, a third sub-frame 303, and a fourth sub-frame 304 for image frame 28. As such, first sub-frame 301, second sub-frame 302, third sub-frame 303, and fourth sub-frame 304 each include a plurality of columns and a plurality of rows of individual pixels 18 of image data 16.

In one embodiment, as illustrated in FIGS. 3B-3D, second sub-frame 302 is offset from first sub-frame 301 by a vertical distance 50 and a horizontal distance 52, third sub-frame 303 is offset from first sub-frame 301 by a horizontal distance 54, and fourth sub-frame 304 is offset from first sub-frame 301 by a vertical distance 56. As such, second sub-frame 302, third sub-frame 303, and fourth sub-frame 304 are each spatially offset from each other and spatially offset from first sub-frame 301 by a predetermined distance. In one illustrative embodiment, vertical distance 50, horizontal distance 52, horizontal distance 54, and vertical distance 56 are each approximately one-half of one pixel.

As illustrated schematically in FIG. 3E, display device 26 alternates between displaying first sub-frame 301 in a first position P₁, displaying second sub-frame 302 in a second position P₂ spatially offset from the first position, displaying third sub-frame 303 in a third position P₃ spatially offset from the first position, and displaying fourth sub-frame 304 in a fourth position P₄ spatially offset from the first position. More specifically, display device 26 shifts display of second sub-frame 302, third sub-frame 303, and fourth sub-frame 304 relative to first sub-frame 301 by the respective predetermined distance. As such, pixels of first sub-frame 301, second sub-frame 302, third sub-frame 303, and fourth sub-frame 304 overlap each other.

In one embodiment, display device 26 performs one cycle of displaying first sub-frame 301 in the first position, displaying second sub-frame 302 in the second position, displaying third sub-frame 303 in the third position, and displaying fourth sub-frame 304 in the fourth position for image frame 28. Thus, second sub-frame 302, third sub-frame 303, and fourth sub-frame 304 are spatially and temporally displayed relative to each other and relative to first sub-frame 301. The display of four temporally and spatially shifted sub-frames in this manner is referred to herein as four-position processing.

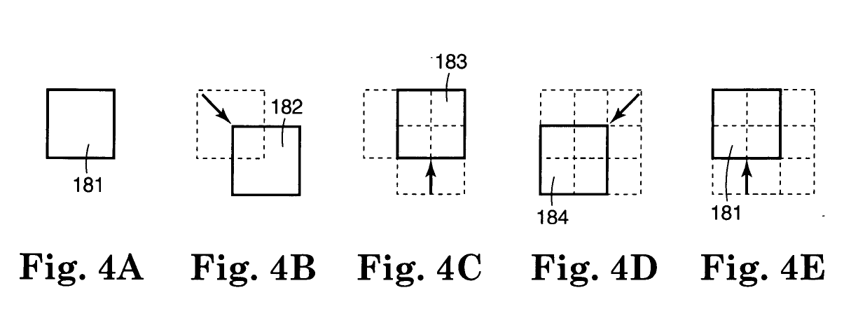

FIGS. 4A-4E illustrate one embodiment of completing one cycle of displaying a pixel 181 from first sub-frame 301 in the first position, displaying a pixel 182 from second sub-frame 302 in the second position, displaying a pixel 183 from third sub-frame 303 in the third position, and displaying a pixel 184 from fourth sub-frame 304 in the fourth position. More specifically, FIG. 4A illustrates display of pixel 181 from first sub-frame 301 in the first position, FIG. 4B illustrates display of pixel 182 from second sub-frame 302 in the second position (with the first position being illustrated by dashed lines), FIG. 4C illustrates display of pixel 183 from third sub-frame 303 in the third position (with the first position and the second position being illustrated by dashed lines), FIG. 4D illustrates display of pixel 184 from fourth sub-frame 304 in the fourth position (with the first position, the second position, and the third position being illustrated by dashed lines), and FIG. 4E illustrates display of pixel 181 from first sub-frame 301 in the first position (with the second position, the third position, and the fourth position being illustrated by dashed lines).

Sub-frame generation unit 36 (FIG. 1) generates sub-frames 30 based on image data in image frame 28. It will be understood by a person of ordinary skill in the art that functions performed by sub-frame generation unit 36 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

In one form of the invention, sub-frames 30 have a lower resolution than image frame 28. Thus, sub-frames 30 are also referred to herein as low resolution images 30, and image frame 28 is also referred to herein as a high resolution image 28. It will be understood by persons of ordinary skill in the art that the terms low resolution and high resolution are used herein in a comparative fashion, and are not limited to any particular minimum or maximum number of pixels. Sub-frame generation unit 36 is configured to use any suitable algorithm to generate pixel values for sub-frames 30.

II. Image Shifter Adjustment and Control

With the embodiment shown of FIG. 1, the display of sub-frames 30 may be affected by external shock or vibration of display device 26 from rotating fans or audio speakers, for example. In particular, external shock or vibration may cause differences between the desired positioning of image shifter 38 and the actual positioning of image shifter 38 in the display of sub-frames 30. These differences may hamper the quality of displayed image 14.

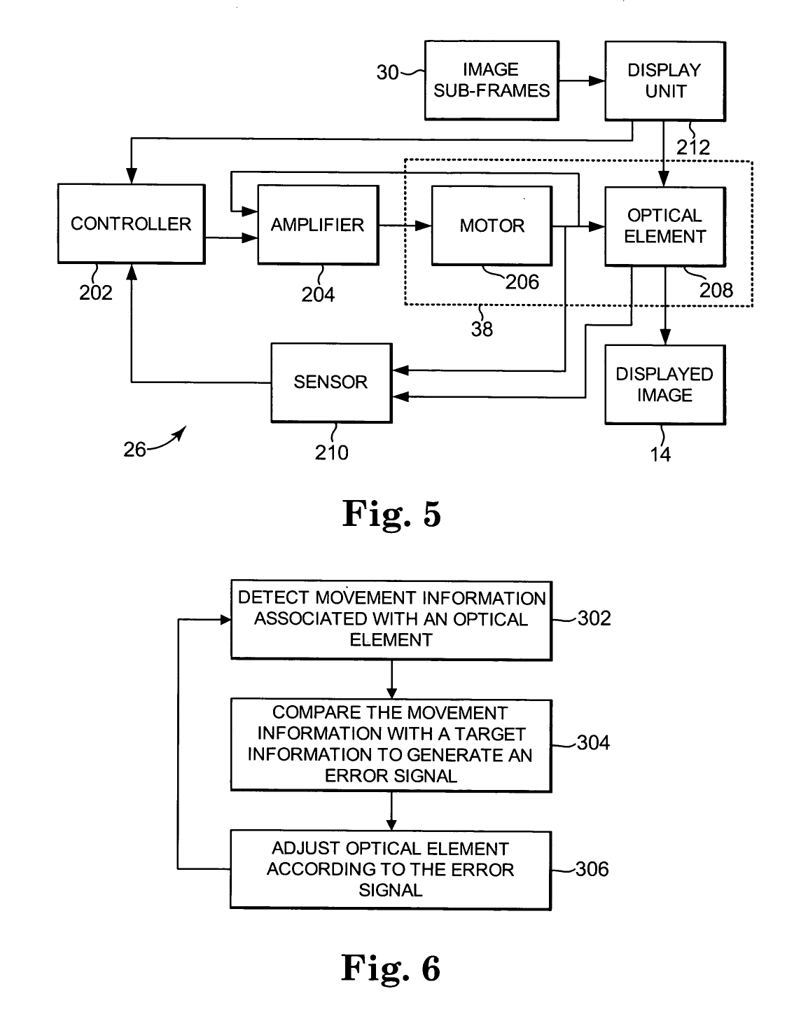

As shown in described with reference to FIGS. 5-8, one or more sensors 210 may be added to operate with display device 26 to provide closed loop feedback in the control of image shifter 38. The use of closed loop feedback may increase disturbance rejection caused by external shock or vibration and increase the quality of displayed image 14. In addition, a closed loop system may compensate for other factors that affect the precise positioning of image shifter 38 such as mechanical or electrical drift, aging, temperature, or other manufacturing or environmental factors.

FIG. 5 is a block diagram illustrating additional details of display device 26 with image shifter 38. In this embodiment, display device 26 includes a controller 202, an amplifier 204, a motor 206, an optical element 208, at least one sensor 210, and a display unit 212. In one embodiment, motor 206 and optical element 208 comprise image shifter 38 as shown in FIG. 1.

In the embodiment of FIG. 5, controller 202, amplifier 204, motor 206, and sensor 210 form a closed loop control system where sensor 210 detects movement of optical element 208 by motor 206 and provides information associated with the movement to controller 202. Controller 202 processes the information from sensor 210, generates an error signal using the information, and provides the error signal to amplifier 204. Amplifier 204 adjusts the operation of motor 206 using the error signal to adjust the position of optical element 208.

Display unit 212 receives image sub-frames 30 and causes image sub-frames 30 to be displayed as displayed image 14. Display unit 212 provides a synchronization signal to controller 202 to synchronize the display of sub-frames 30 with the control of motor 206 and optical element 208. Motor 206 and optical element 208 perform the functions of image shifter 38 (as described above with reference to FIG. 1) where motor 206 moves or otherwise adjusts optical element 208 to cause sequential sub-frames 30 to be displayed at different, but overlapping, positions on a display surface as described in the examples shown in FIGS. 2A-2C, 3A-3E, and 4A-4E. Display unit 212 includes any suitable display unit such as a digital micromirror device (DMD), a transmissive liquid crystal display (LCD), or an LCOS display configured to display image sub-frames 30 on a display surface. Display unit 212 may form a front or rear projection system. Optical element 208 includes any suitable reflective or refractive optical element such as an optical plate of glass or an optical mirror.

The operation of display device 26 will now be described with reference to FIG. 6. FIG. 6 is a flow chart illustrating a method for controlling optical element 208. In FIG. 6, sensor 210 detects movement information associated with optical element 208 as indicated in a block 302. Sensor 210 includes any suitable type of physical or electromechanical sensor configured to detect movement of optical element 208. Sensor 210 may include an optically based sensor, a Hall effect sensor, a capacitive sensor, an inductive LVDT sensor, an eddy current sensor, or a piezo sensor, for example.

The movement information detected by sensor 210 may include position information that identifies one or more absolute or relative positions of optical element 208, velocity information that identifies one or more absolute or relative velocities of optical element 208, acceleration information that identifies one or more absolute or relative accelerations of optical element 208, or any combination of position, velocity, acceleration, or other information.

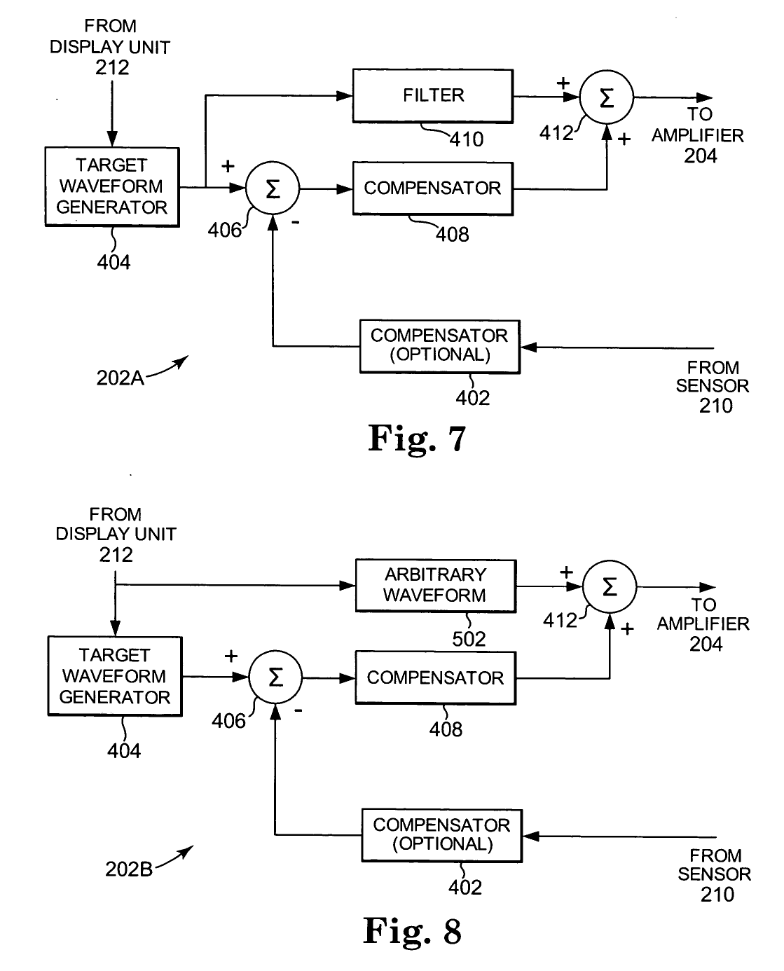

Sensor 210 provides the movement information to controller 202. Controller 202 compares the movement information with target information to generate an error signal as indicated in a block 304. The target information includes any suitable information that may be compared to the movement information to determine a difference between the actual movement of optical element 208 and the desired location of optical element 208 at a point in time. In one embodiment, the target information is time synchronized to the display of image sub-frames 30 using the synchronization signal received from display unit 212. For example, the target information may include the output of a target waveform generator as described with reference to the embodiments in FIGS. 7 and 8 below. The target information may include any combination of position information, velocity information, acceleration information, or other information.

Controller 202 generates the error signal according to the difference between the movement information from sensor 210 and the target information. Controller 202 provides the error signal to amplifier 204. Amplifier 204 and motor 206 adjust optical element 208 according to the error signal as indicated in a block 306. Amplifier 204 generates a correction signal according to the error signal and provides the correction signal to motor 206 to cause motor 206 to move or otherwise adjust optical element 208 in a desired way. The correction signal may be a voltage or current signal that drives motor 206 to cause optical element 208 to be adjusted.

Motor 206 includes any suitable motor configured to move or otherwise adjust optical element 208. In one embodiment, motor 206 includes a voice coil motor that is configured to angle optical element 208 about one or more axes to cause successive image sub-frames 30 to be displayed at overlapping positions on a display surface to create displayed image 14.

In other embodiments, the output from motor 206 may be provided to amplifier 204 and/or sensor 210 as local or state variable feedback. In other embodiments, display device 26 includes other numbers of sensors 210 that are configured to provide state variable feedback to controller 202. In these embodiments, each sensor 210 may detect and provide the same or different types of information to controller 202.

In one embodiment, controller 202 and portions of amplifier 204 and sensor 210 may be implemented in an application specific integrated circuit (ASIC). The ASIC may also include other components configured to perform other functions of display device 26. For example, the ASIC may also control micromirror motion in a DMD.

Controller 202 comprises any suitable combination of hardware and/or software components such as a microprocessor, a microcontroller, firmware, and/or a gate array. Any software components may be stored in any suitable portable or non-portable computer-readable media. In addition, controller 202, amplifier 204, and sensor 216 may include any suitable combination of analog and/or digital components.

Although shown in FIG. 5 as part of display device 26, controller 202, sensor 210, and/or other components the embodiment of FIG. 5 may be housed separately from display device 26 in other embodiments.

FIG. 7 is a block diagram illustrating an embodiment of controller 202 for controlling optical element 208. In the embodiment of FIG. 7, a controller 202A includes an optional compensator 402, a target waveform generator 404, a differencing system 406, a compensator 408, a filter 410, and a feed forward system 412.

Compensator 402 receives the movement information from sensor 210. Compensator 402 filters the movement information to reduce noise and/or processes the movement information to convert the movement information to another type or multitude of types of movement information. For example, compensator 402 may convert velocity information to position information. Compensator 402 provides the movement information to a negative input of differencing system 406.

Target waveform generator 404 generates a target waveform that represents the desired movement information of optical element 208. In one embodiment, target waveform generator 404 generates the target waveform as a square wave, e.g., a 60 Hz square wave, and synchronizes the target waveform with the frame rate of display unit 212 using the synchronization signal from display unit 212. Target waveform generator 404 provides the target waveform to a positive input of differencing system 406 and to filter 410.

Differencing system 406 computes a difference between the movement information from compensator 402 and the target waveform from target waveform generator 404 to generate a difference signal. Differencing system 406 provides the difference signal to compensator 408.

Compensator 408 filters the difference signal and provides correct gain and phase margin for the closed loop system of controller 202A, amplifier 204, motor 206, and sensor 210. Compensator 408 introduces filtering action for control and stability of the closed loop system. Compensator 408 includes any suitable compensator such as a proportional integral derivative (PID) compensator, a lead compensator, a lag compensator, a state variable compensator, a notch filtering compensator, or any combination of compensators. A notch filtering compensator may reduce the amplitude of unwanted resonances of the difference signal. Compensator 408 may also include an integrator to improve low frequency tracking ability and improve disturbance rejection.

Filter 410 shapes the target waveform from target waveform generator 404 and provides the shaped target waveform to feed forward system 412. In one embodiment, filter 410 shapes the target waveform into an arresting pulse to reduce the amount of closed loop control system overshoot that may occur in feedback systems that do not have a large amount of damping.

Feed forward system 412 sums the difference signal and the shaped target waveform to generate a control signal. Feed forward system 412 provides the control signal to amplifier 204. Feed forward system 412 may improve the dynamic performance and lessen the requirements for control feedback in the closed loop control system. Feed forward system 412 may be used in concert with the feedback from sensor 210 to optimize the overall control of optical element 208.

FIG. 8 is a block diagram illustrating another embodiment of controller 202 for controlling optical element 208. In the embodiment of FIG. 8, a controller 202B includes optional compensator 402, target waveform generator 404, differencing system 406, compensator 408, feed forward system 412, and an arbitrary waveform generator 502.

In the embodiment of FIG. 8, optional compensator 402, target waveform generator 404, differencing system 406, and compensator 408 operate as described above with reference to FIG. 7. Arbitrary waveform generator 502, rather than target waveform generator 404, provides an arbitrary waveform to feed forward system 412. In one embodiment, arbitrary waveform generator 502 synchronizes the arbitrary waveform with the display of image sub-frames 30 using the synchronization signal from display unit 212. Feed forward system 412 sums the difference signal and the arbitrary waveform to generate a control signal and provides the control signal to amplifier 204.

In one embodiment, all or selected portions of controller 202 may be implemented in an ASIC. For example, all or any of compensator 402, target waveform generator 404, differencing system 406, compensator 408, filter 410, feed forward system 412, and arbitrary waveform generator 502 may be implemented in an ASIC along with the low signal portion of amplifier 204 and/or the electronics portion of sensor 210. The ASIC may also include other components configured to perform other functions of display device 26. For example, the ASIC may also control micromirror motion in a DMD.

The use of closed loop feedback in the embodiments described above may improve system rejection of disturbances caused by external shock or vibration and increases the quality a displayed image. In addition, a closed loop system in these embodiments may compensate for other factors that affect the precise positioning of optical element 208 such as mechanical or electrical drift, aging, temperature, or other manufacturing or environmental factors. For example, the parameters of motor 206 may change significantly over time without degrading the ability of the closed loop control system to track and control the desired position of optical element 208.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A system for displaying an image using at least a first sub-frame and a second sub-frame, the system comprising:
an image shifter configured to cause the first sub-frame to be displayed at a first position on a display surface and the second sub-frame to be displayed at a second position on the display surface;
a sensor configured to detect a movement of the image shifter; and
a controller configured to receive movement information associated with the movement of the image shifter from the sensor.

2. The system of claim 1 wherein the controller is configured to compare the movement information to target information to generate a signal.

3. The system of claim 2 wherein the image shifter includes an optical element configured to be adjusted in accordance with the signal.

4. The system of claim 2 wherein the sensor is configured to provide the movement information to the controller.

5. The system of claim 2 wherein the controller includes a target waveform generator configured to generate the target information.

6. The system of claim 1 wherein the first position at least partially overlaps with the second position.

7. The system of claim 1 wherein the movement information includes one or more of position information, velocity information, and acceleration information.

8. The system of claim 1 wherein the controller includes a feed forward system.

9. The system of claim 1 wherein the controller includes a proportional integral derivative (PID) compensator.

10. The system of claim 1 wherein the image shifter includes an optical element and a motor configured to adjust the optical element to cause the first sub-frame to be displayed at the first position and the second sub-frame to be displayed at the second position.

11. A system for displaying an image using at least a first sub-frame and a second sub-frame, the system comprising:
means for causing the first sub-frame to be displayed at a first position on a display surface and the second sub-frame to be displayed at a second position on the display surface;
means for generating movement information from the means for causing the first sub-frame to be displayed at the first position and the second sub-frame to be displayed at the second position; and
means for comparing the movement information to target information to generate a signal.

12. The system of claim 11 further comprising:
means for providing the signal to the means for causing the first sub-frame to be displayed at a first position on a display surface and the second sub-frame to be displayed at a second position the display surface.

13. The system of claim 11 further comprising:
means for generating the target information.

14. The system of claim 11 wherein the first position at least partially overlaps with the second position.

15. The system of claim 11 wherein the movement information includes one or more of position information, velocity information, and acceleration information.

16. A method of making a display system configured to display an image using at least a first sub-frame and a second sub-frame, the method comprising:
providing an image shifter configured to cause the first sub-frame to be displayed at a first position on a display surface and the second sub-frame to be displayed at a second position on the display surface;
providing a sensor configured to detect a movement of the image shifter; and
providing a controller configured to receive movement information associated with the movement of the image shifter from the sensor.

17. The method of claim 16 wherein the controller is configured to compare the movement information to target information to generate a signal.

18. The method of claim 17 wherein the image shifter includes an optical element configured to be adjusted in accordance with the signal.

19. The method of claim 17 wherein the sensor is configured to provide the movement information to the controller.

20. The method of claim 17 wherein the controller includes a target waveform generator configured to generate the target information.

21. The method of claim 16 wherein the first position at least partially overlaps with the second position.

22. The method of claim 16 wherein the movement information includes one or more of position information, velocity information, and acceleration information.

23. The method of claim 16 wherein the image shifter includes an optical element and a motor configured to adjust the optical element to cause the first sub-frame to be displayed at the first position and the second sub-frame to be displayed at the second position.

24. A method of displaying an image using at least a first sub-frame and a second sub-frame, the method comprising:
generating the first sub-frame and the second sub-frame;
causing the first sub-frame to be displayed at a first position on a display surface and the second sub-frame to be displayed at a second position on the display surface;
generating movement information associated with causing the first sub-frame to be displayed at the first position; and
comparing the movement information to target information to generate a signal.

25. The method of claim 24 further comprising:
adjusting an image shifter using the signal.

26. The method of claim 24 further comprising:
generating the target information.

27. The method of claim 24 wherein the first position at least partially overlaps with the second position.

28. The method of claim 24 wherein the movement information includes one or more of position information, velocity information, and acceleration information.

29. A program product stored in computer readable medium and having instructions for causing a computer to execute a method comprising:
comparing movement information associated with an image shifter configured to cause a first sub-frame to be displayed at a first position on a display surface and a second sub-frame to be displayed at a second position on the display surface with target information; and
generating a signal configured to adjust the image shifter in response to comparing the movement information with the target information.

30. The program product of claim 29 wherein the movement information includes one or more of position information, velocity information, and acceleration information.
